(19) United States
(12) Patent Application Publication
(10) Pub. No.: US 2026/0356195 A1
(43) Pub. Date: Nov. 12, 2026

(54) WIGGLE CAR

(71) Applicant: Shenzhen Youshi Technology Co., Ltd., Shenzhen (CN)

(72) Inventors: Qiuyan Luo, Shenzhen (CN); Xing Tan, You (CN)

(21) Appl. No.: 19/405,713

(22) Filed: Dec. 2, 2025

(30) Foreign Application Priority Data
May 8, 2025 (CN) 202520899668.8
May 8, 2025 (CN) 202520903687.3
Nov. 13, 2025 (CN) 202522412728.1

(51) Int. Cl. B60K 35/22; B60K 26/02; B60K 35/26; B62D 1/04; B62K 9/02

(52) U.S. Cl. CPC B60K 35/22; B60K 26/02; B60K 35/26; B62D 1/04; B62K 9/02

(57) ABSTRACT

A wiggle car includes a body assembly configured for a user to ride in; a wheel assembly arranged at a bottom of the body assembly and comprising a front wheel assembly arranged at a front end of the body assembly and a rear wheel assembly arranged at a rear end of the body assembly; a steering wheel assembly connected to the body assembly and the front wheel assembly and configured to drive the front wheel assembly to rotate to allow the user change a forward direction of the wheel assembly by operating the steering wheel assembly; a display assembly arranged on a front outer surface of the body assembly and configured to display predetermined patterns or texts; and a control assembly, comprising a power switch key and a circuit board; both the power switch key and the circuit board are connected to the circuit board.

### CROSS-REFERENCE TO RELATED APPLICATIONS

The application claims priorities of Chinese Patent Application No. CN202520903687.3, filed on May 8, 2025, Chinese Patent Application No. CN 202520899668.8, filed on May 8, 2025, and Chinese Patent Application No. CN 202522412728.1, filed on Nov. 13, 2025, the entire contents of which are incorporated herein by reference.

### FIELD

The present disclosure relates to children's toys, and in particular, to a wiggle car.

### BACKGROUND

A wiggle car, also known as a twist car, can be operated simply by swaying a steering wheel left and right with one's hands. It is affordably priced and suitable for parent-child activities.

However, most wiggle cars available on the market generally only allow for riding and twisting, offering limited entertainment values. Since wiggle cars are designed for children, and children have a limited attention span, they may quickly find riding them uninteresting and refuse to continue after a short while. This results that accompanying adults have to take care of both the children and the wiggle car, which is quite inconvenient and leads to a poor user experience.

### SUMMARY

In order to solve shortcomings in existing technologies, the present disclosure is to provide a wiggle car, which can improve user experience.

A wiggle car provided by the present disclosure includes a body assembly configured for a user to ride in; a wheel assembly arranged at a bottom of the body assembly and comprising a front wheel assembly arranged at a front end of the body assembly and a rear wheel assembly arranged at a rear end of the body assembly; a steering wheel assembly connected to the body assembly and the front wheel assembly and configured to drive the front wheel assembly to rotate to allow the user change a forward direction of the wheel assembly by operating the steering wheel assembly; a display assembly arranged on a front outer surface of the body assembly and configured to display predetermined patterns or texts; and a control assembly, comprising a power switch key and a circuit board; both the power switch key and the circuit board are connected to the circuit board.

Compared with existing technologies, the wiggle car provided in the embodiments of the present disclosure can display the predetermined patterns and/or text during the use of the wiggle car by configuring the display component, enhancing the entertainment of the wiggle car and providing a better user experience.

In at least one embodiment, the wiggle car further includes a first electrical connection assembly connected to the front wheel assembly via a first wire and configured to rotate along with the front wheel assembly when the front wheel assembly is driven to rotate by the steering wheel assembly; and a second electrical connection assembly connected to the circuit board via a second wire and configured to be mounted on the body assembly. The first electrical connection assembly is configured to keep resisting against the second electrical connection assembly to ensure an electrical connection between the first electrical connection assembly and the second electrical connection assembly during rotation of the first electrical connection assembly along with the front wheel assembly.

In at least one embodiment, the wiggle car further includes a support member connected to the body assembly. The support member is configured to sleeve on the steering wheel assembly and is rotatable relative to the steering wheel assembly. Both the circuit board and the second electrical connection assembly are arranged on the support member.

In at least one embodiment, the first electrical connection assembly includes a rotating body configured to sleeve on the steering wheel assembly and two electrical ring pieces disconnected from each other. The rotating body is configured to be mounted on the front wheel assembly and is rotatably arranged inside the support member. The first electrical connection assembly further includes a second electrical connection assembly, connected to the circuit board via a second wire and configured to be mounted on the body assembly. The first electrical connection assembly is configured to keep resisting against the second electrical connection assembly to ensure an electrical connection between the first electrical connection assembly and the second electrical connection assembly during rotation of the first electrical connection assembly along with the front wheel assembly. Two leads at an end of the first wire are connected to the two electrical ring pieces respectively. The second electrical connection assembly includes two electrical contact assemblies. The support member is provided with two first mounting slots corresponding to the two electrical ring pieces respectively. The two electrical contact assemblies are configured to be arranged in the two first mounting slots respectively. Two first through-holes are defined in the two first mounting slots respectively and are configured to allow the two electrical contact assemblies to pass therethrough to resists against the two electrical ring pieces respectively. Two leads at an end of the second wire are connected to the two electrical contact assemblies respectively.

In at least one embodiment, the front wheel assembly is provided with a placement slot on a side facing the support member. The second electrical connection assembly includes a rotating body configured to sleeve on the steering wheel assembly and two electrical ring pieces disconnected from each other. The rotating body is configured to be mounted on an inner side of the support member and is rotatably arranged in the placement slot. The two electrical ring pieces are arranged on an outer side of the rotating body, or, one of the two electrical ring pieces is arranged on the outer side of the rotating body and another of the two electrical ring pieces is arranged on a bottom surface of the support member facing the front wheel assembly. Two leads at an end of the second wire are connected to the two electrical ring pieces respectively. The first electrical connection assembly includes two electrical contact assemblies. The front wheel assembly is provided with two second mounting slots corresponding to the two electrical ring pieces respectively. The two electrical contact assemblies are configured to be arranged in the two second mounting slots respectively. Two second through-holes are defined in the two second mounting slots respectively and are configured to allow the two electrical contact assemblies to pass therethrough to resists against the two electrical ring pieces respectively. Two leads at an end of the first wire are connected to the two electrical contact assemblies respectively.

In at least one embodiment, each of the first electrical connection assembly and the second electrical connection assembly includes an electrical ring piece and an electrical contact assembly, and each of the support member and the front wheel assembly is provided with a third mounting slot. One of the two electrical ring pieces is arranged on an upper surface of the front wheel assembly facing the support member, and another of the two electrical ring pieces is arranged on a bottom surface of the support member facing the front wheel assembly. The third mounting slot on the front wheel assembly corresponds to the third mounting slot on the support member. The two electrical contact assemblies are configured to be mounted on the two third mounting slots respectively. Two leads at an end of the first wire are connected to the electrical ring piece on the front wheel assembly and the electrical contact assembly on the front wheel assembly. Two leads at an end of the second wire are connected to the electrical ring piece on the support member and the electrical contact assembly on the support member.

In at least embodiment, the second electrical connection assembly includes two electrical ring pieces arranged on a bottom surface of the support member facing the front wheel assembly and disconnected from each other. Two leads at an end of the second wire are connected to the two electrical ring pieces. The first electrical connection assembly includes two electrical contact assemblies. The front wheel assembly is provided with two fourth mounting slots corresponding to the two electrical ring pieces. The two electrical contact assemblies are configured to be mounted in the two fourth mounting slots and are configured to resists against the two electrical ring pieces respectively. Two leads at an end of the first wire are connected to the two electrical contact assemblies.

In at least one embodiment, each electrical ring piece is connected with a pin having a third through-hole configured to allow the first wire or the second wire to pass therethrough to be electrically connected to the electrical ring piece.

In at least one embodiment, each electrical contact assembly includes an electrical contact block configured to resists against a corresponding one of the two electrical ring piece and a reset member. One end of the reset member is configured to resists against the first mounting slot, and another end of the reset member is configured to resist against the electrical contact block.

In at least one embodiment, a mounting protrusion is arranged at a side of the electrical contact block facing the reset member and the reset member is configured to sleeve on the mounting protrusion.

In at least one embodiment, the body assembly includes an upper shell and a lower shell connected to each other to define an accommodation cavity. The upper shell includes a seat plate, a front plate connected to the seat plate, two side plates connected to the seat plate and two opposite sides of the front plate, and two foot pedals connected to an outer side of the two side plates respectively. The display assembly includes a display element arranged on an outer side of the front plate. The display assembly further includes a decorative shell. The decorative shell includes a first decorative part configured to cover a side of the display element opposite to the front plate. The first decorative part includes a translucent material configured to allow the display element to display predetermined patterns and/or text via the first decorative part. By arranging the structure of the body assembly, the riding experience for children becomes safer and more comfortable. Meanwhile, the display elements, through the first decorative part of the transparent material, display the predetermined patterns and/or text, which can make the display clearer and provide a better user experience.

In at least one embodiment, the seat plate includes a seat plate body and an operation panel connected between the seat plate and the front plate. The control assembly includes at least one adjustment control key arranged on the operation panel. The at least one adjustment control key is electrically connected to the circuit board and is configured to generate control signals based on user's operation. The circuit board is configured to control display of the display assembly and functions of other functional assemblies. The other functional assemblies include a speaker assembly and a light assembly and a light assembly; and functions of the other functional assemblies include sound, music and light effects. By configuring the control assembly, users can control aspects such as sound, music, and/or lighting effects through the adjustment control keys. This enables the display assembly to display the patterns and/or text controlled by the user, and/or uses the speaker assembly and/or the lighting assembly of the other functional assemblies to play music and/or lighting effects. This enhances the entertainment value of the wiggle car and increases the operational enjoyment for the user.

In at least one embodiment, the operation panel is arranged on the upper shell of the device. The second decorative part has an opening for exposing at least one adjustment control key. The at least one adjustment control key includes a horn key, a display assembly mode switch key, a lighting mode switch key, a music control key, a volume adjustment key, and a music adjustment key. The music control key, the volume adjustment key, and the music adjustment key are arranged adjacent to the seat plate body. The horn key, the lighting mode switch key, and the display assembly mode switch key are arranged adjacent to the steering wheel assembly. The horn key is located between the lighting mode switch key and the display assembly mode switch key. By configuring the horn key, the display assembly mode switch key, the light mode switch key, the music control key, the volume adjustment key and the music adjustment key, it becomes easier for children to operate.

In at least one embodiment, the display assembly comprise a light panel and a light cover configured to cover the light panel; the light panel includes a panel body and a plurality of light-emitting elements arranged on the panel body. The plurality of light-emitting elements include LEDs, the light cover includes a plurality of light-transmitting holes corresponding to the plurality of light-emitting elements respectively and a plurality of spacing parts arranged among the plurality of light-emitting elements. Each light-emitting element corresponds to a corresponding one of the plurality of light-transmitting holes. The spacing part are made of light-shielding material configured to isolate light from adjacent light-emitting elements. The display assembly further includes a diffusion film. The diffusion film includes a silk-screened film layer with multiple spaced-apart light-transmitting regions. Each light-transmitting region corresponds to a corresponding one of the light-transmitting holes. The silk-screened film layer is a black light-shielding film layer. Each light-transmitting region is configured to diffuse light out from the corresponding one of the light-transmitting holes to have light emitted from the display assembly softer. The light emitted by the light panel is configured to pass sequentially through the light-transmitting holes and the light-transmitting regions and to be emitted via the decorative shell to allow the decorative shell to display the predetermined patterns. The predetermined patterns include at least one of numbers, letters, characters and preset graphics. The front plate defines a wiring hole configured to allow a wire to pass therethrough to connect the display assembly and the circuit board.

In at least one embodiment, the rear wheel assembly is detachably connected to the body assembly. The wiggle car further includes a motor arranged in the front wheel assembly and electrically connected to the circuit board. The wiggle car further includes a pedal switch electrically connected to the control assembly and is configured to output a control signal to control the motor to drive the front wheel assembly to work when operated by the user.

In at least one embodiment, the wheel assembly further includes a rear wheel mounting bracket arranged in the accommodation cavity; and at least part of the rear wheel assembly is configured to pass through the lower shell to be detachably connected to the rear wheel mounting bracket. By configuring the front wheel assembly to connect with the steering wheel assembly, the user can change the forward direction of the wheel assembly by operating the steering wheel assembly, which is simple and convenient to operate and more suitable for children to use. Meanwhile, the rear wheel assembly is detachably connected with the body assembly, which can facilitate disassembly for the user during transportation and/or maintenance and replacement.

In at least one embodiment, the lower shell further includes a first mounting hole and a second mounting hole. The lower shell is configured to at least partially pass through the first mounting hole to be detachably connected to the rear wheel mounting bracket. A fastening member is configured to pass through the second mounting hole from an outer side of the lower shell to be detachably connected to the rear wheel assembly to detachably mount the wheel assembly onto the body assembly. By configuring the said fastening member, a detachable connection between the rear wheel assembly and the rear wheel mounting bracket can be achieved. The structure is simple and the operation is convenient.

In at least one embodiment, the lower shell includes a bottom plate, a side extension plate, and a recessed part connected between the bottom plate and the side extension plate. The recessed part defines a third mounting hole. The rear wheel assembly includes an outer shell and a rear wheel at least partially accommodated in the outer shell. An outer side of the outer shell is provided with at least two mounting shaft parts. The mounting shaft parts are inclined relative to a horizontal direction after being mounted onto the rear wheel mounting bracket. The mounting shaft parts are configured to pass through the third mounting hole to be detachably engaged with a fourth mounting hole on the rear wheel mounting bracket. By configuring the mounting shaft parts and the reinforcing members, the reinforcing members can be reinforcing steel bars, which can ensure the connection strength between the rear wheel assembly and the lower shell. The mounting shaft parts can be installed at an angle relative to the horizontal direction, thereby better fitting with the rear wheel mounting bracket. In addition, the design of the two mounting shaft parts also makes the rear wheel assembly less prone to swinging and has a larger force-bearing area. The space usage is more flexible. Meanwhile, by configuring the fastening member and cooperating with the fastening screw, the rear wheel assembly and the lower shell can be locked tightly, and the connection between them is stable and not easy to come apart.

In at least one embodiment, the mounting shaft parts are of a hollow structure. The rear wheel assembly further includes two reinforcing members. The two reinforcing members are at least partially arranged in the hollow structure and extends into the fourth mounting hole. The fastening member includes a fixed post fixedly connected to the outer shell, a fastening screw, and a nut pressing plate. The fixed post defines a fifth mounting hole. The fastening screw is configured to sequentially pass through the second mounting hole on the lower shell and the fifth mounting hole on the fixed post to be connected with the nut pressing plate, so as to mount the rear wheel assembly onto the lower shell.

In at least one embodiment, the rear wheel mounting bracket and the lower shell are connected through a screw. The outer shell includes a first housing and a second housing arranged on two opposite sides of the rear wheel respectively. Wheel axles on both sides of the rear wheel are fixed in through-holes on the first housing and the second housing respectively. Two nuts are fastened onto the wheel axles on both sides of the rear wheel and are located on the outer side of the outer shell. The rear wheel assembly further includes a decorative cover. The second housing is arranged between the first housing and the body assembly, and the decorative cover is arranged on a side of the first housing opposite to the rear wheel. By configuring the first housing and the second housing and fixing the rear wheel therein, the rear wheel can be made more stable, ensuring the safety of use.

In at least one embodiment, the steering wheel assembly includes a steering wheel and a connecting structure connected to a side of the steering wheel. The connecting structure is configured to pass through the body assembly to be connected to the front wheel assembly. The front wheel assembly includes a mounting structure, a front wheel arranged on a front side of the mounting structure, and two auxiliary wheels arranged on a rear side of the mounting structure. By configuring the connecting structure and the mounting structure, the steering wheel assembly can be stably connected with the body assembly. Moreover, by arranging the two auxiliary wheels located at the rear side of the installation structure and the front wheel at the front side of the installation structure, a triangular stable structure is formed, making the wiggle car more stable and safer during use. It can be better used in different road conditions, enhancing the user experience.

Comparing with existing technologies, the wiggle car provided by the embodiments of the present disclosure.

### BRIEF DESCRIPTION OF THE DRAWINGS

To more clearly illustrate technical solutions in the embodiments of the present disclosure, a brief description will now be given to accompanying drawings required for the description of the embodiments of the present disclosure. It is evident that the accompanying drawings described below merely represent some embodiments of the present disclosure. For those of ordinary skilled in the art, other accompanying drawings can be obtained based on structures depicted in these drawings without need for creative effort.

FIG. 1 is a schematic structural diagram of a wiggle car according to an embodiment of the present disclosure.

FIG. 2 is a schematic structural diagram of the wiggle car from another angle according to the embodiment of the present disclosure.

FIG. 3 is an exploded view of the wiggle car of FIG. 1 from a first perspective.

FIG. 4 is an exploded view of a first example of a wire-free electrical connection in the present disclosure.

FIG. 5 is an enlarged view of the potion C shown in FIG. 3.

FIG. 6 is an exploded view of a variant example of the first example.

FIG. 7 is an enlarged view of the potion D shown in FIG. 5.

FIG. 8 is an exploded view of a first electrical connection assembly and a second electrical connection assembly in the variant example of the first example.

FIG. 9 is an exploded view of a second example of the wire-free electrical connection in the present disclosure.

FIG. 10 is an exploded view of the second example of the wire-free electrical connection from another angle.

FIG. 11 is an exploded view of a rotating body and an electrical contact assembly in the second example.

FIG. 12 is an exploded view of a variant example of the second example.

FIG. 13 is an exploded view of a first electrical connection assembly and a second electrical connection assembly in the variant example of the second example.

FIG. 14 is an exploded view of a front wheel assembly in the variant example of the second example.

FIG. 15 is an exploded view of a third example of the wire-free electrical connection in the present disclosure.

FIG. 16 is an exploded view of the third example of the wire-free electrical connection from another angle.

FIG. 17 is an exploded view of a fourth example of the wire-free electrical connection in the present disclosure.

FIG. 18 is an exploded view of a first electrical connection assembly and a second electrical connection assembly in fourth example.

FIG. 19 is an exploded view of the wiggle car shown in FIG. 1 from a second perspective.

FIG. 20 is an exploded view of the wiggle car shown in FIG. 1 from a third perspective.

FIG. 21 is an enlarged view of the portion A shown in FIG. 19.

FIG. 22 is a schematic view of a diffusion film of a display assembly of the wiggle car of FIG. 1.

FIGS. 23-25 illustrates a first dynamic emoji of big eyes displayed by the display assembly of the wiggle car in FIG. 1.

FIGS. 26-27 illustrates a letter dynamic emoji displayed by the display assembly of the wiggle car in FIG. 1.

FIGS. 28-29 illustrates a heart-shaped dynamic emoji displayed by the display assembly of the wiggle car in FIG. 1.

FIGS. 30-35 illustrates dynamic glasses emoticons displayed by the display assembly of the wiggle car in FIG. 1.

FIGS. 36-37 illustrates happy dynamic emoticons displayed by the display assembly of the wiggle car in FIG. 1.

FIGS. 38-39 illustrates confused dynamic emoticons displayed by the display assembly of the wiggle car in FIG. 1.

FIG. 40 illustrates a second dynamic emoji of the big eyes displayed by the display assembly of the wiggle car in FIG. 1.

FIG. 41 is an enlarged view of the portion B shown in FIG. 19.

FIG. 42 is an exploded view of a rear wheel assembly of the wiggle car shown in FIG. 1.

FIG. 43 is an exploded view of a rear wheel assembly of the wiggle car shown in FIG. 1 from another angle.

FIG. 44 is a cross-sectional view of a rear part of the wiggle car shown in FIG. 1.

### DETAILED DESCRIPTION

Hereinafter, technical solutions in the embodiments of the present disclosure will be described clearly and completely in conjunction with accompanying drawings in the embodiments of the present disclosure. It is apparent that described embodiments are merely a part of the embodiments of the present disclosure, rather than all of them. Based on the embodiments in the present disclosure, all other embodiments obtained by those of ordinary skilled in the art without making creative efforts shall fall within the protection scope of the present disclosure.

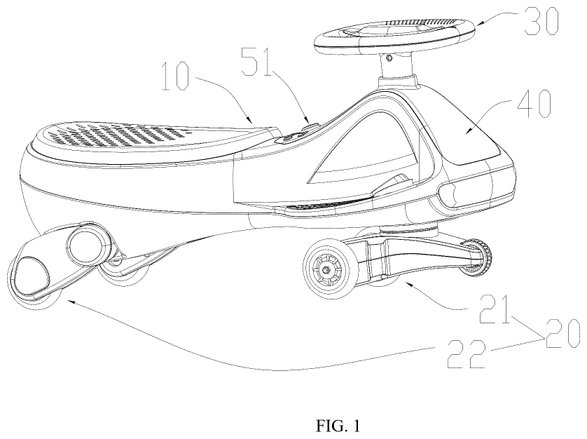

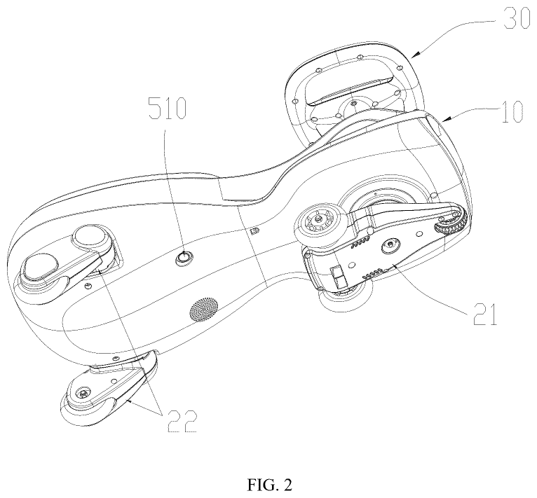

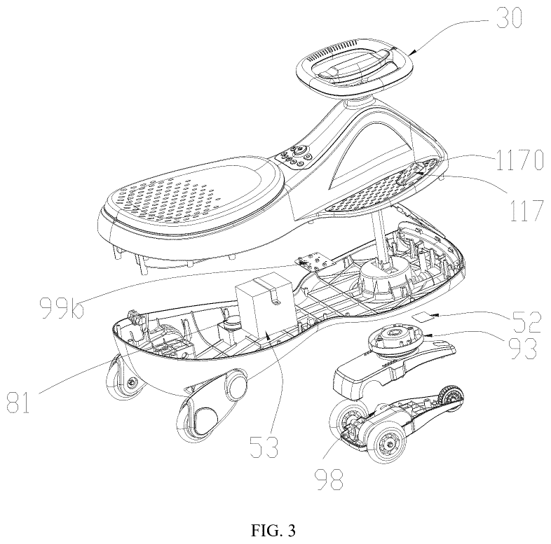

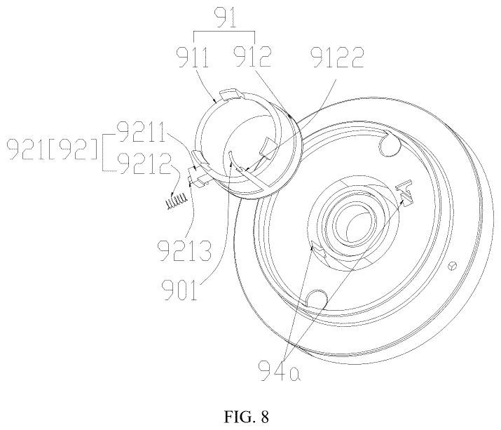

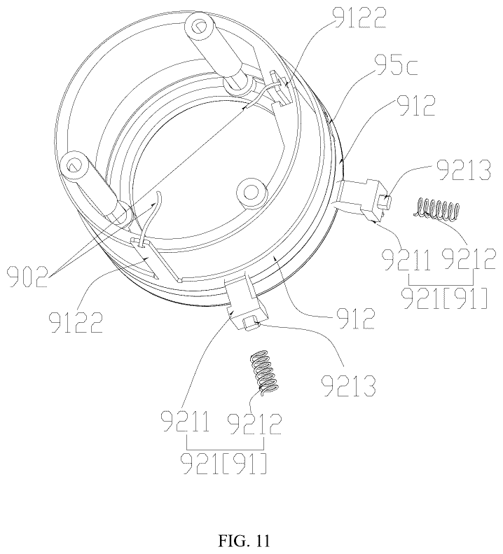

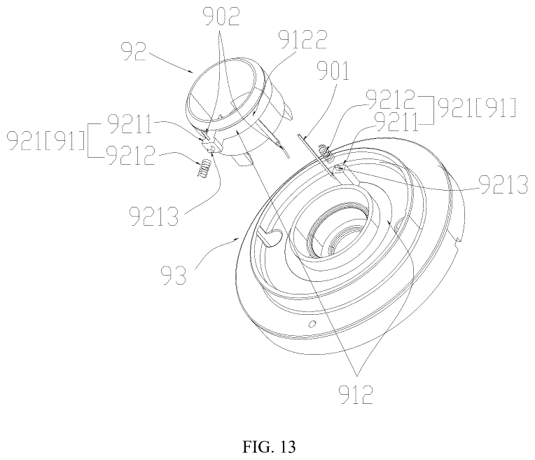

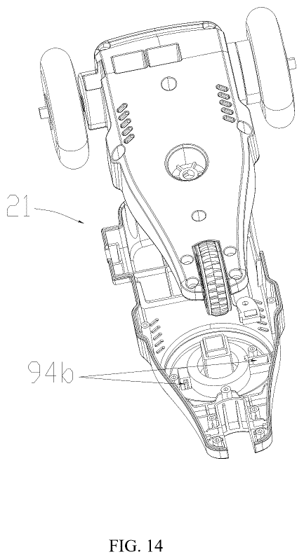

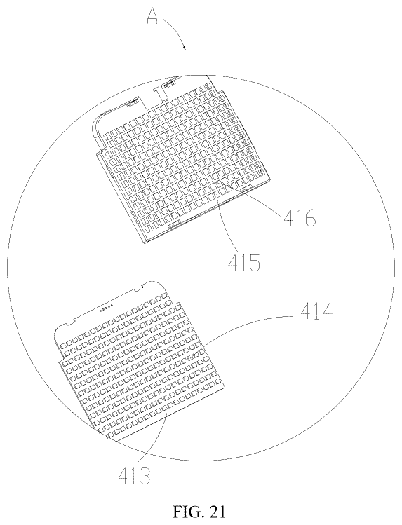

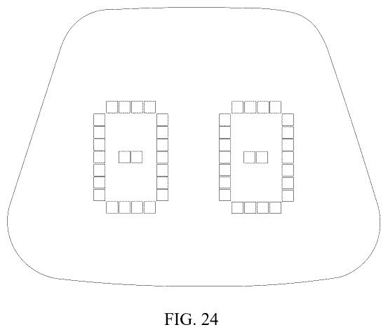

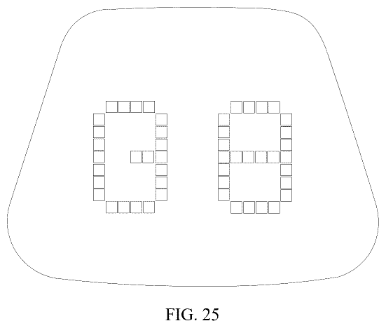

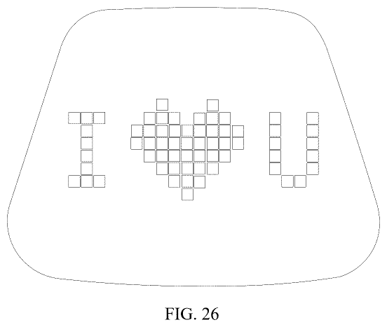

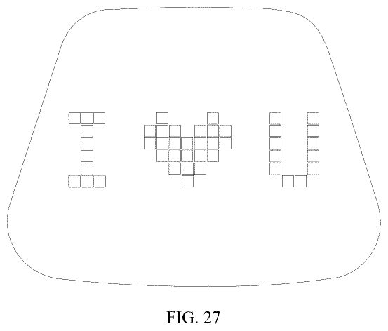

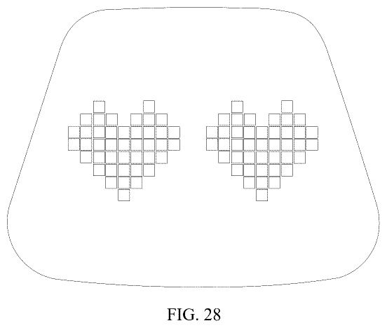

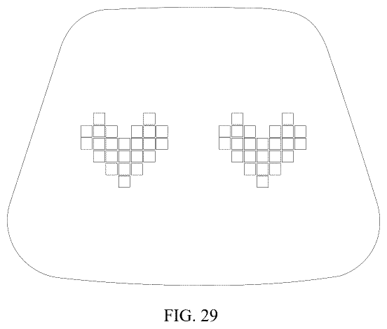

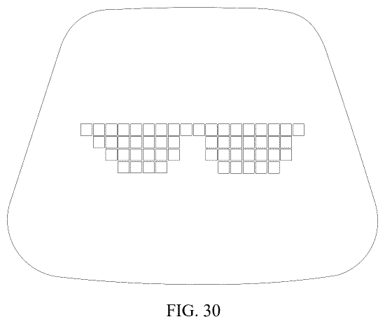

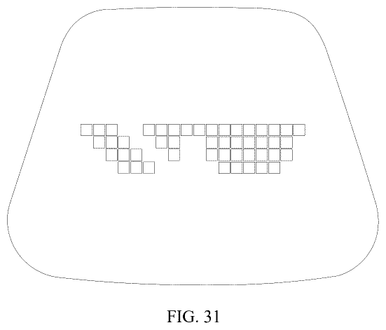

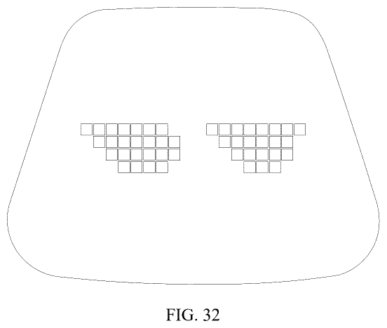

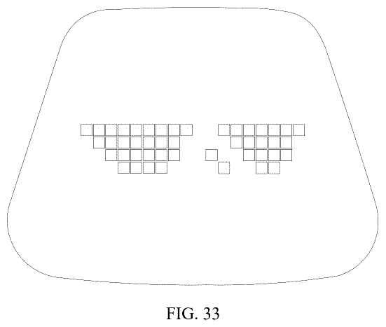

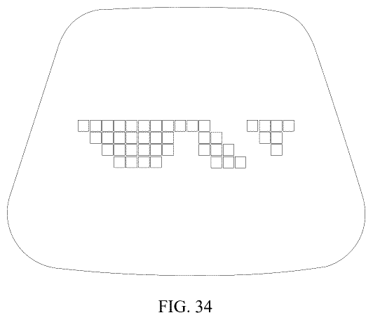

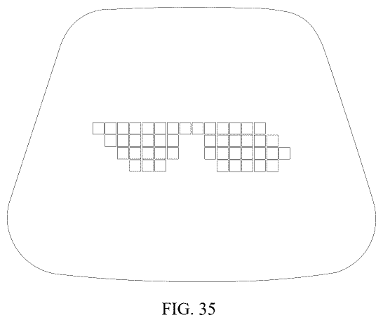

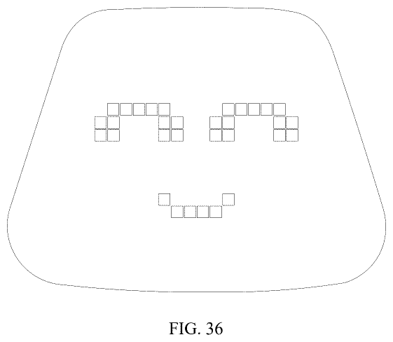

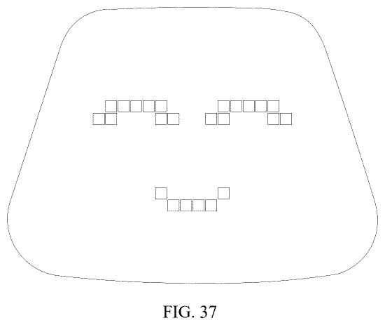

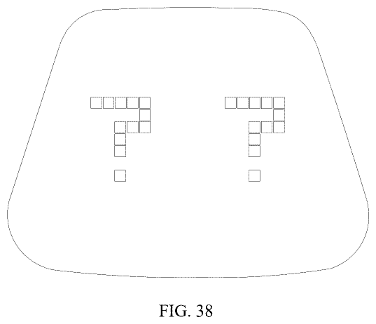

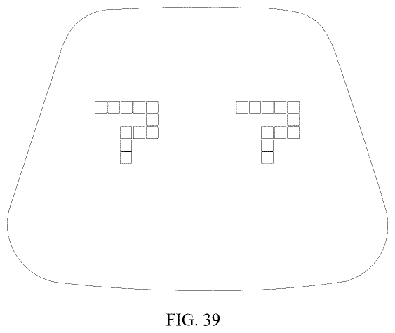

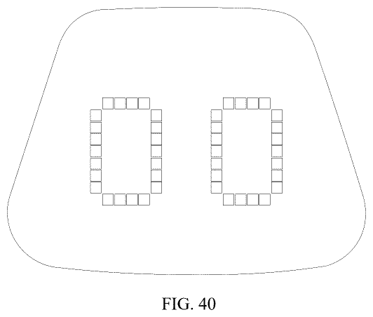

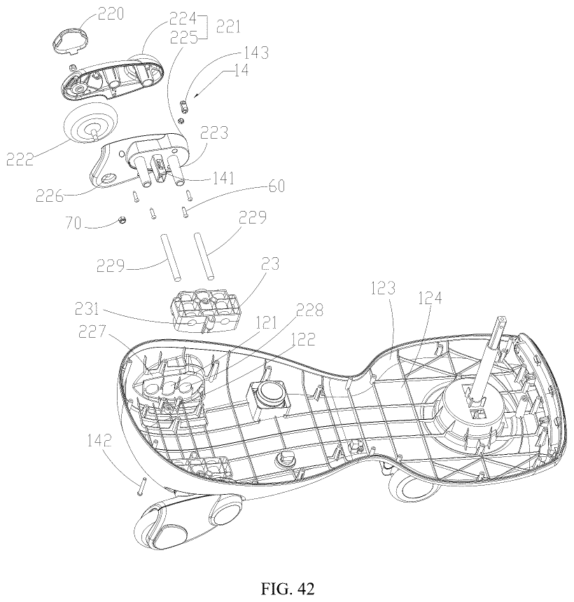

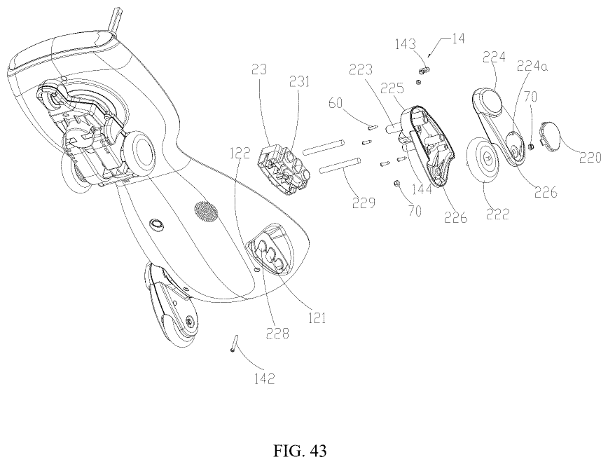

Referring to FIGS. 1 to 43, an embodiment of the present disclosure provides a wiggle car 1, which includes: a body assembly 10, a wheel assembly 20, a steering wheel assembly 30, and a display assembly 40. The body assembly 10 is configured for a user to sit on. The wheel assembly 20 is mounted at a bottom of the body assembly and include a front wheel assembly 21 and a rear wheel assembly 22. The front wheel assembly 21 is positioned adjacent to a front end of the body assembly 10, while the rear wheel assembly 22 is positioned adjacent to a rear end of the body assembly 10. The steering wheel assembly 30 connects the body assembly 10 and the front wheel assembly 21, and the steering wheel assembly 30 drives the front wheel assembly 21 to rotate, enabling the user to manipulate a direction of the steering wheel assembly 30 to change a forward direction of the wheel assembly 20. The connection between the body assembly 10 and the steering wheel assembly 30 can be achieved through bearings (not labeled), which can ensure that the body assembly 10 does not rotate along with the steering wheel assembly 30. The display assembly 40 is arranged on a front outer surface of the body assembly 10 and is configured to display predetermined patterns and/or text. The wiggle car 1 further includes a control assembly 50, which includes a power switch key 510 and a circuit board 52. Both the power switch key 510 and the display assembly 40 are electrically connected to the circuit board 52. The power switch key 510 can be an inductive power switch key or a manual switch button. The power switch key 510 is preferably the manual switch button. Moreover, it is preferable to position the manual switch button at the bottom of the body assembly 10 to prevent children from accidentally touching it while playing with the wiggle car, thereby ensuring their safety, as shown in FIG. 2.

It can be understood that users of the wiggle car 1 are generally young children. They can sit on the body assembly 10 and operate the wiggle car 1 to move forward or turn using the steering wheel assembly 30. Additionally, the display assembly 40 can display predetermined patterns and/or text for the children to interact with, attracting their attention and enhancing their interest in playing with the wiggle car 1, making the process of accompanying children more relaxing. By incorporating the display assembly 40, predetermined patterns and/or text can be displayed during the use of the wiggle car 1, enhancing its entertainment value and providing a better user experience.

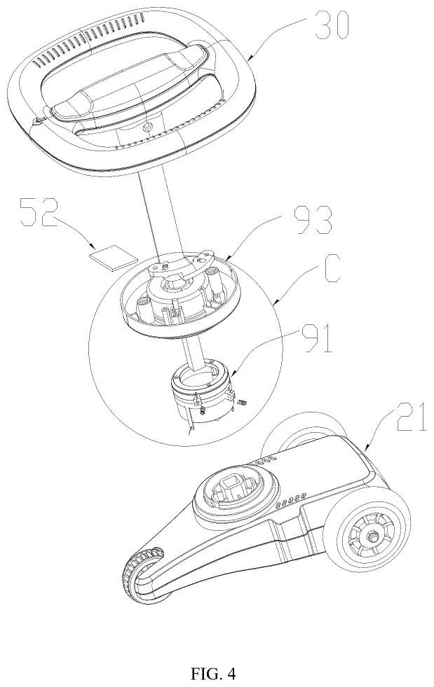

Furthermore, as shown in FIGS. 4 to 18, the wiggle car 1 further includes a first electrical connection assembly 91 and a second electrical connection assembly 92. The first electrical connection assembly 91 is electrically connected to the front wheel assembly 21 via a first wire 901. When the steering wheel assembly 30 drives the front wheel assembly 21 to rotate, the first electrical connection assembly 91 is driven to rotate along with the front wheel assembly 21. The second electrical connection assembly 92 is electrically connected to the circuit board 52 via a second wire 902 and is mounted on the body assembly 10. The first electrical connection assembly 91 remains in constant contact with the second electrical connection assembly 92, ensuring a continuous electrical connection between the first electrical connection assembly 91 and the second electrical connection assembly 92 as the first electrical connection assembly 91 rotates along with the front wheel assembly 21. By establishing an indirect electrical connection through the contact between the first electrical connection assembly 91 and the second electrical connection assembly 92, rather than a direct wire connection to the front wheel assembly 21, the steering wheel assembly 30 can drive the front wheel assembly 21 to rotate 360 degrees, enhancing fun of children playing with the wiggle car 1. Moreover, the 360-degree rotation of the front wheel assembly 21 driven by the steering wheel assembly 30 may spark children's interest in the structure of the wiggle car 1. Parental explanations can further enhance children's knowledge and increase interaction between parents and children, enhancing the entertainment value of the wiggle car and providing a better user experience.

Furthermore, as illustrated in FIGS. 4 to 18, the wiggle car further includes a support member 93 that is connected to the body assembly 10 and rotatably mounted around the steering wheel assembly 30. The support member 93 can rotate relative to the steering wheel assembly 30. Both the circuit board 52 and the second electrical connection assembly 92 are positioned on the support member 93. A primary function of the support member 93 is to accommodate the circuit board 52. Since most control buttons are typically located adjacent the front end of the wiggle car, and the front wheel assembly is situated beneath the front end, mounting the circuit board 52 on the support member 93 facilitates electrical connections of the second electrical connection assembly 92, the power switch key 510, and other electrical connectors (such as a foot pedal 117) to the circuit board 52. Therefore, arrangement of the support member 93 can reduce wiring distances of components electrically connected to the circuit board 52, facilitating overall layout and subsequent maintenance and repair.

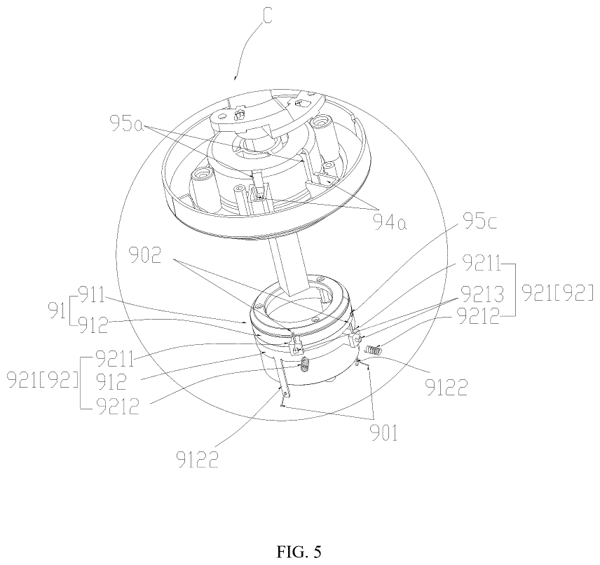

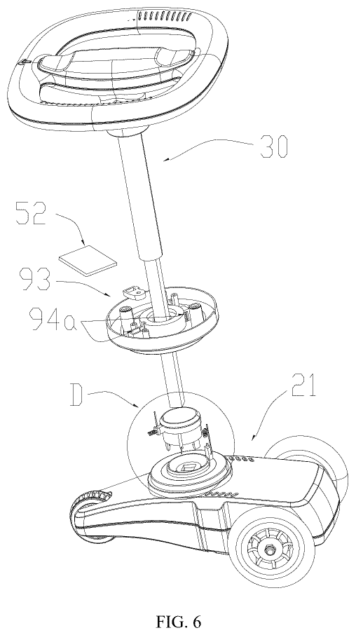

Furthermore, as shown in FIGS. 4 to 5, it illustrates a first example of a wire-free electrical connection between the first electrical connection assembly 91 and the second electrical connection assembly 92. The first electrical connection assembly 91 includes a rotating body 911 and two electrical ring pieces 912. The rotating body 911 is mounted around the steering wheel assembly 30, installed on the front wheel assembly 21, and rotatably positioned inside the support member 93. The two electrical ring pieces 912 are mounted on the outer side of the rotating body 911 and are disconnected from each other. Two leads at one end of the first wire 901 are respectively connected to the two electrical ring pieces 912. The second electrical connection assembly 92 includes two electrical contact assemblies 921. Two first mounting slots 94a are provided on the support member 93 for the two electrical ring pieces 912 respectively, and the two electrical contact assemblies 921 are respectively installed in the two first mounting slots 94a. Each of the two first mounting slots 94a is provided with a first through-hole 95a, through which the electrical contact assemblies 921 can pass to contact the electrical ring pieces 912. The two leads at one end of the second wire 902 are respectively connected to the two electrical contact assemblies 921. As shown in FIGS. 6 to 8, in another embodiment, one of the two electrical ring pieces 912 can be installed on the outer side of the rotating body 911, and the other of the two electrical ring pieces 912 can be installed on the top surface of the front wheel assembly 21 facing the support member 93, with the two electrical ring pieces 912 being disconnected. Both the two electrical contact assemblies 921 are mounted on the support member 93, two leads at one end of the second wire 902 are connected to the two electrical contact assemblies 921 respectively, and two leads at one end of the first wire are connected to the two electrical ring pieces 912 respectively. Remaining connection structures remain the same with above example. Specifically, the rotating body 911 and the two electrical ring pieces 912 are installed on the front wheel assembly 21, while the electrical contact assemblies 921 are installed on the support member 93. The support member 93 and the body assembly 10 do not rotate with the steering wheel assembly 30. When the steering wheel assembly 30 drives the front wheel assembly 21 to rotate, the rotating body 911 and the electrical ring pieces 912 rotate along with the front wheel assembly 21, and the first wire 901 also rotates with the front wheel assembly 21. This ensures that when the steering wheel assembly 30 drives the front wheel assembly 21, there will be no wire entanglement issues, allowing the steering wheel assembly to drive the front wheel assembly 21 to achieve a 360-degree rotation.

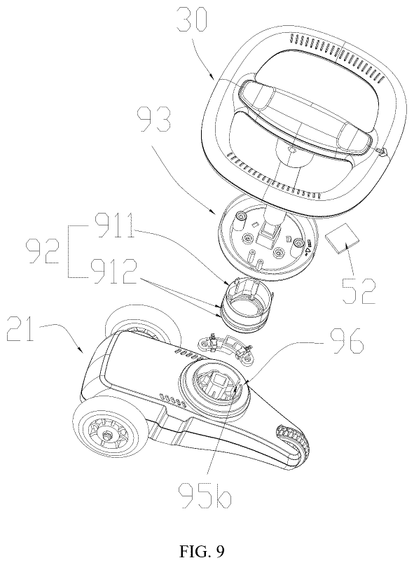

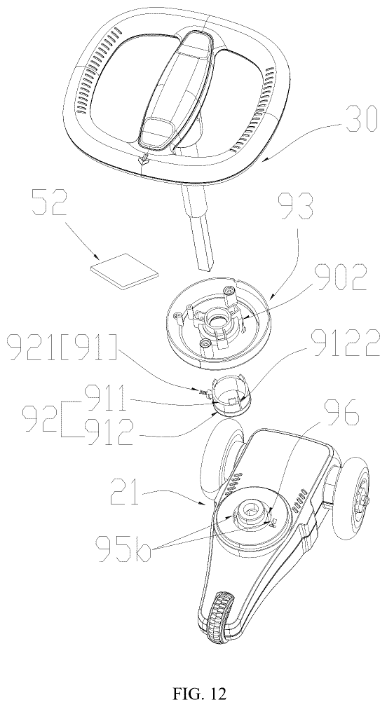

Furthermore, as shown in FIGS. 9 to 11, in a second example of the wire-free electrical connection between the first electrical connection assembly 91 and the second electrical connection assembly 92, a placement slot 96 is provided on the surface of the front wheel assembly 21 facing the support member 93. The second electrical connection assembly 92 includes a rotating body 911 and two electrical ring pieces 912. The rotating body 911 is fixedly installed inside the support member 93, mounted around the steering wheel assembly 30, and rotatably positioned within the placement slot 96. The two electrical ring pieces 912 are mounted on the outer side of the rotating body 911 and are disconnected from each other. The first electrical connection assembly 91 includes two electrical contact assemblies 921. Two second mounting slots 94b are correspondingly provided on the front wheel assembly 21 for the two electrical ring pieces 912, and the two electrical contact assemblies 921 are respectively installed in the two second mounting slots 94b. Each of the two second mounting slots 94b is provided with a second through-hole 95b, through which the electrical contact assemblies 921 can pass to contact the electrical ring pieces 912. The two leads at one end of the first wire 901 are respectively connected to the two electrical contact assemblies 921. As shown in FIGS. 12 to 14, in another embodiment, one electrical ring piece 912 can be installed on the outer side of the rotating body 911, and the other electrical ring piece 912 can be installed on the bottom surface of the support member 93 facing the front wheel assembly 21, with the two electrical ring pieces 912 being disconnected. The two leads at one end of the second wire 902 are respectively connected to the two electrical ring pieces 912. The two electrical contact assemblies 921 are mounted on the front wheel assembly 21 and corresponds to the electrical ring piece 912 on the rotating body and the electrical ring piece 912 on the support member 93, and remaining connection structures remains the same with above second example. Specifically, the rotating body 911 and the electrical ring pieces 912 are installed on the support member 93, while the electrical contact assemblies 921 are installed on the front wheel assembly 21. The support member 93 and the body assembly 10 do not rotate with the steering wheel assembly 30. When the steering wheel assembly 30 drives the front wheel assembly 21 to rotate, the electrical contact assemblies 921 rotate along with the front wheel assembly 21, and the first wire 901 also rotates with the front wheel assembly 21. This ensures that when the steering wheel assembly 30 drives the front wheel assembly 21, there will be no wire entanglement issues, allowing the steering wheel assembly 30 to drive the front wheel assembly 21 to achieve a 360-degree rotation.

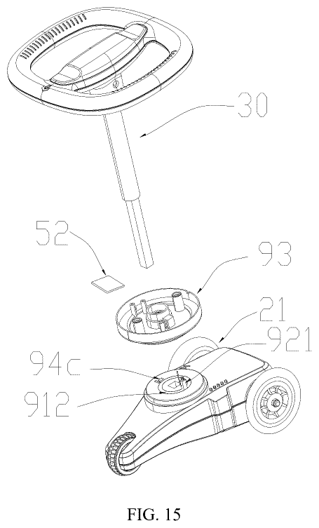

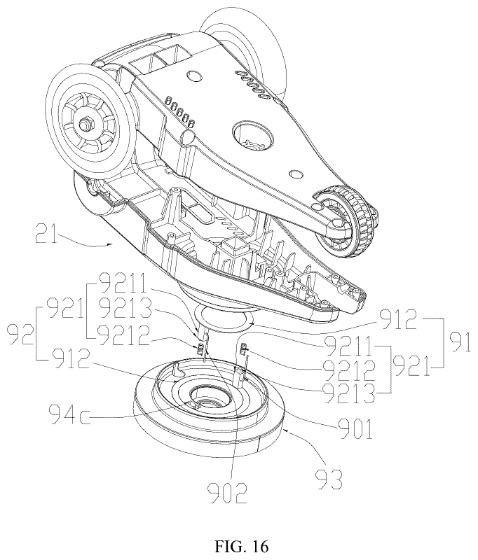

Furthermore, as shown in FIGS. 15 to 16, in a third example of the wire-free electrical connection between the first electrical connection assembly 91 and the second electrical connection assembly 92, both the first electrical connection assembly 91 and the second electrical connection assembly 92 include an electrical ring piece 912 and an electrical contact assembly 921. Both the support member 93 and the front wheel assembly 21 are equipped with third mounting slots 94c. One electrical ring piece 912 is installed on the top surface of the front wheel assembly 21 facing the support member 93, and the third mounting slot 94c on the support member 93 is positioned corresponding to the electrical ring piece 912 on the front wheel assembly 21. The other electrical ring piece 912 is installed on the bottom surface of the support member 93 facing the front wheel assembly 21, and the third mounting slot 94c on the front wheel assembly 21 is positioned corresponding to the third mounting slot 94c on the support member 93. The two electrical contact assemblies 921 are respectively placed within the two third mounting slots 94c. The two leads at one end of the first wire 901 are respectively connected to the electrical ring piece 912 and the electrical contact assembly 921 installed on the front wheel assembly 21, while the two leads at one end of the second wire 902 are respectively connected to the electrical ring piece 912 and the electrical contact assembly 921 installed on the support member 93. Compared with the aforementioned two examples, this third example cancels the rotating body, instead placing the two electrical ring pieces 912 on the support member and the front wheel assembly, respectively, while installing corresponding electrical contact assemblies 921 on both the support member and the front wheel assembly. This results in a simpler structure and lower costs.

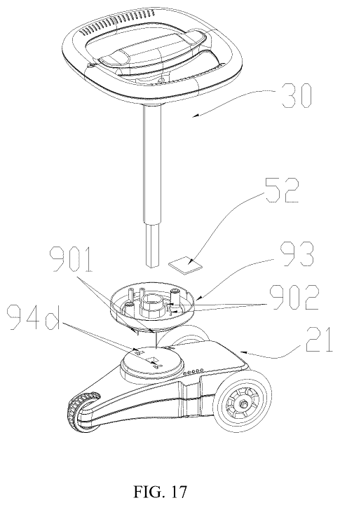

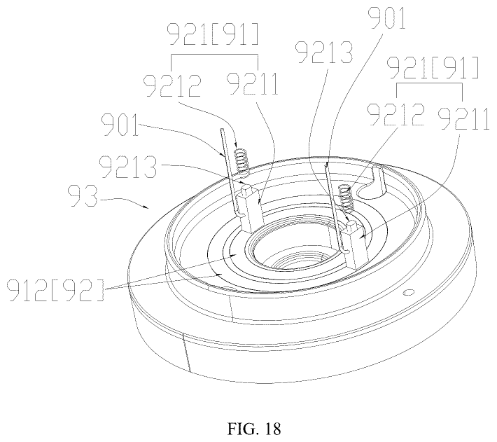

Furthermore, as shown in FIGS. 17 to 18, in a fourth example of the wire-free electrical connection between the first electrical connection assembly 91 and the second electrical connection assembly 92, the second electrical connection assembly 92 includes two electrical ring pieces 912, both of which are placed on the bottom surface of the support member 93 facing the front wheel assembly 21 and are disconnected from each other. The two leads at one end of the second wire 902 are respectively connected to the two electrical ring pieces 912. The first electrical connection assembly 91 includes two electrical contact assemblies 921, and the front wheel assembly 21 is equipped with fourth mounting slots 94d corresponding to the two electrical ring pieces 912. The two electrical contact assemblies 921 are respectively installed in the two fourth mounting slots 94d and are respectively in contact with the two electrical ring pieces 912. The two leads at one end of the first wire 901 are respectively connected to the two electrical contact assemblies 921. Compared with the first and second examples, this fourth example also cancels the rotating body. Compared with the third example, it is simpler, with both electrical ring pieces 912 placed on the support member 93 and both electrical contact assemblies 921 installed on the front wheel assembly 21, resulting in a simpler electrical connection structure and simplified processes.

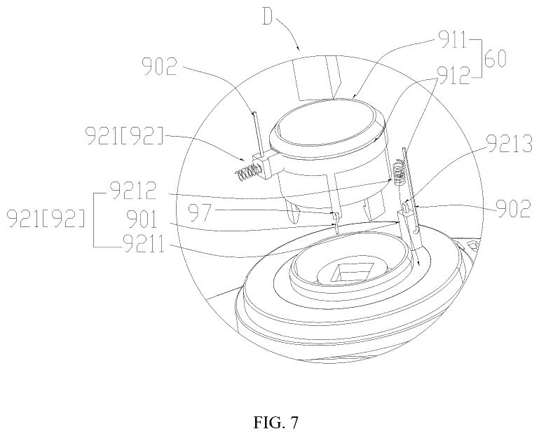

Furthermore, as shown in FIGS. 4 to 13, in the first to fourth examples of the wire-free electrical connection between the first electrical connection assembly 91 and the second electrical connection assembly 92, the electrical ring piece 912 is connected with a pin 9122. The electrical ring piece 912 and the pin 9122 are integrally formed. A sleeve hole 97 (as shown in FIG. 7) can also be provided on the pin for easier wire connection. In the first example, the rotating body 911 is equipped with a third through-hole 95c adjacent to one electrical ring piece 912 that is away from the front wheel assembly 21. The pin 9122 passes through the third through-hole 95c and extends from the inner side of the rotating body towards the front wheel assembly 21. In the second example, the rotating body 911 is equipped with a third through-hole 95c adjacent to the electrical ring piece 912 that is away from the support member 93. The pin 9122 passes through the third through-hole 95c and extends from the inner side of the rotating body towards the support member 93. Since a wire routing distance of the first wire or the second wire is relatively long in the first and second examples, it is recommended to provide the pins 9122 to facilitate wire connections. In the third and fourth examples, the pins 9122 may or may not be provided, as the electrical ring pieces are directly placed on the support member and/or the front wheel assembly, resulting in a shorter wire routing distance that does not affect the connection.

Furthermore, as shown in FIGS. 4 to 18, in the first to fourth examples where the first electrical connection assembly 91 and the second electrical connection assembly 92 are wirelessly electrically connected. The electrical contact assembly 921 includes an electrical contact block 9211 and a reset member 9212. The electrical contact block 9211 abuts against the electrical ring piece 912, and one end of the reset member 9212 abuts against the wall of the mounting slot where the electrical contact block 9211 is located, while the other end of the reset member 9212 abuts against the electrical contact block 9211. The reset member 9212 can be a spring, rubber, or an elastic sheet. Preferably, the reset member 9212 a spring. Due to its low cost and superior elastic reset force, the spring can ensure more stable rotation when the electrical ring piece 912 abuts and rotates against the electrical contact block 9211. The electrical contact block can be a block of copper.

Furthermore, as shown in FIGS. 4 to 18, one end of the electrical contact block 9211 facing the reset member 9212 is provided with a mounting protrusion 9213, around which the reset member 9212 is fitted. The arrangement of the mounting protrusion 9213 facilitates the installation of the reset member 9212.

Furthermore, each of the two leads at one end of the second wire 902 and each of the two leads at one end of the first wire 901 consist of a positive and a negative lead, which is conventional and will not be elaborated on here. The rotating body 911 is generally cylindrical, possibly in the form of a cylindrical tube, facilitating the abutting rotation between the electrical contact assembly 921 and the electrical ring piece 912.

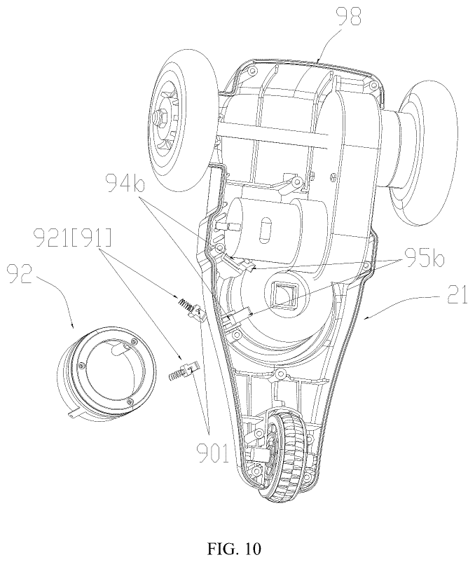

Furthermore, as shown in FIG. 10, a motor 98 in the wiggle car is housed within the front wheel assembly 21 and is electrically connected to the first electrical connection assembly 91 via the first wire 901. The motor 98, housed within the front wheel assembly 21, rotates together with the first wire 901 and the first electrical connection assembly 91 those are driven by the steering wheel assembly 30.

The above provides four examples of the wire-free electrical connection between the first electrical connection assembly 91 and the second electrical connection assembly 92. The first and second embodiments each having two different variations, resulting in a total of six examples for the wire-free electrical connection between the first electrical connection assembly 91 and the second electrical connection assembly 92. The structural arrangements of these six examples facilitate the 360-degree rotation of the front-drive wheel set, enhancing children's interest in the wiggle car. Additionally, the arrangement of the support member for mounting the circuit board facilitates the electrical connection of other electrical components, and the inclusion of the display assembly further enhances children's interest in the wiggle car, improving the user experience.

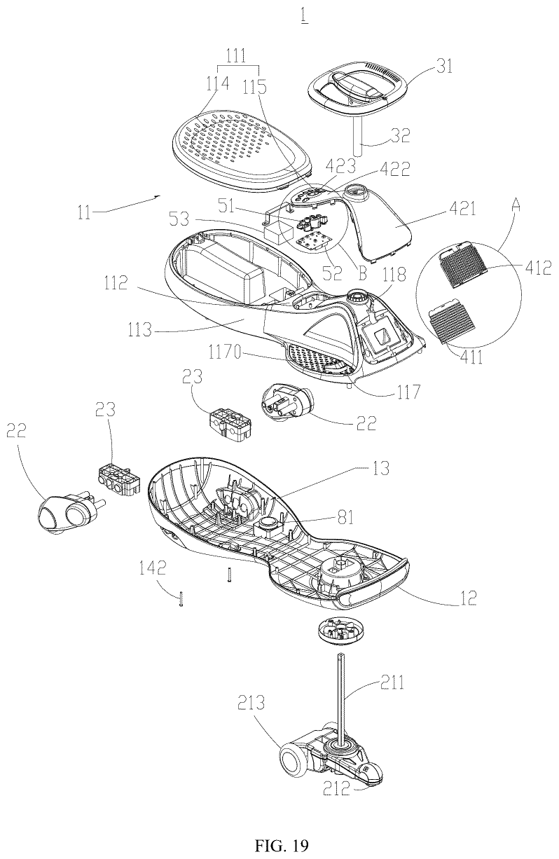

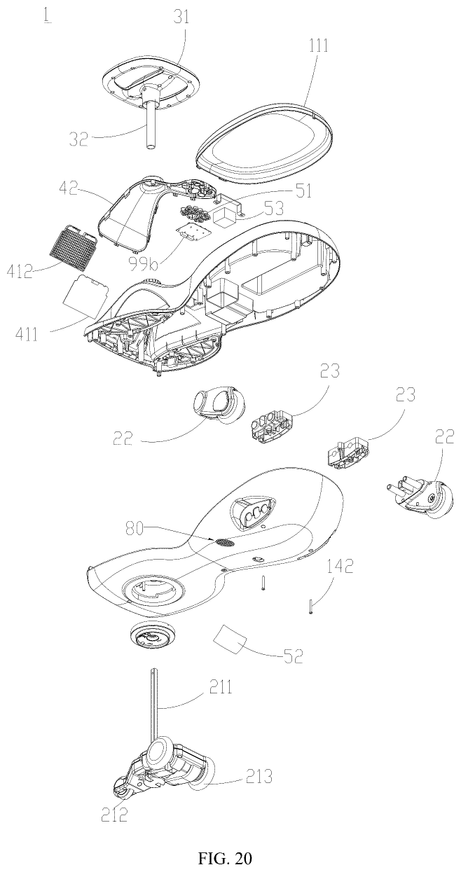

Furthermore, as shown in FIGS. 19 to 20, the vehicle body assembly 10 includes an upper shell 11 and a lower shell 12, which are connected to form an accommodation cavity 13. The upper shell 11 includes a seat plate 111, a front plate 112 connected to the front side of the seat plate 111, two side plates 113 connected to the seat plate 111 and both sides of the front plate 112, and two foot pedals 117 connected to outer sides of the two side plates 113. The display assembly 40 includes a display element 41, which is placed on the outer side of the front plate 112. The display assembly 40 further includes a decorative shell 42, which includes a first decorative part 421 covering the side of the display element 41 away from the front plate 112. The first decorative part 421 includes a translucent material, allowing the display element 41 to display predetermined patterns and/or text via the first decorative part 421. By configuring the structure of the vehicle body assembly 10, children can ride more safely and comfortably. Meanwhile, the display element 41 displaying predetermined patterns and/or text via the first decorative part 421 made of translucent material allows for clearer display and a better user experience.

Furthermore, as shown in FIGS. 19, 20, and 41, the seat plate 111 includes a seat plate body 114 and an operation panel 115 connected between the seat plate body 114 and the front plate 112. The control assembly 50 includes at least one adjustment control key 51, which is placed on the operation panel 115. The control assembly 50 further includes a battery 53 and a Bluetooth control board 99b, both located within the accommodation cavity 13. The Bluetooth control board 99b is electrically connected to the battery 53, the display assembly 40, and the adjustment control keys 51. The adjustment control keys 51 are configured to be operated by users to generate control signals, enabling the Bluetooth control board 99b to control the display of the display assembly 40 and/or functions of other functional assemblies 80 based on these control signals. The other functional assemblies include a speaker assembly 81 and/or a lighting assembly (not shown). Functions of the other functional assemblies 80 encompasses sound, music, and/or lighting effects. The decorative shell 42 further includes a second decorative part 422, which is connected to the first decorative part 421 and covers the operation panel 115. In this embodiment, when children ride the wiggle car 1, they can set the sound, music, and/or lighting effects of the wiggle car 1 using the adjustment control keys 51 of the control assembly 50. Subsequently, the speaker assembly 81 can play the set music externally, enhancing children's enjoyment and increasing their operational pleasure with the wiggle car 1. By incorporating the control assembly 50, users can manipulate sound, music, and/or lighting effects via the adjustment control keys 51, thereby displaying user-manipulated patterns and/or text on the display assembly 40 and/or playing music and/or lighting effects using the speaker assembly 81 and/or the lighting assembly of the other functional assemblies 80. This enhances entertainment values of the wiggle car 1 and increases user operational pleasure.

Furthermore, as shown in FIGS. 19, 20, and 41, the operation panel 115 is arranged on the upper shell 11, and the second decorative part 422 defines at least one opening 423 to expose the at least one adjustment control key 51. The at least one adjustment control key 51 includes a horn key 511, a display assembly mode switch key 512, a lighting mode switch key 513, a music control key 514, a volume adjustment key 515, and a music adjustment key 516. The music control key 514, the volume adjustment key 515, and the music adjustment key 516 are positioned adjacent to the seat plate body 114, while the horn key 511, the lighting mode switch key 513, and the display assembly mode switch key 512 are located adjacent to the steering wheel assembly 30. The horn key 511 is arranged between the lighting mode switch key 513 and the display assembly mode switch key 512. By providing the horn key 511, the display assembly mode switch key 512, the lighting mode switch key 513, the music control key 514, the volume adjustment key 515, and the music adjustment key 516, children can operate the wiggle car more easily.

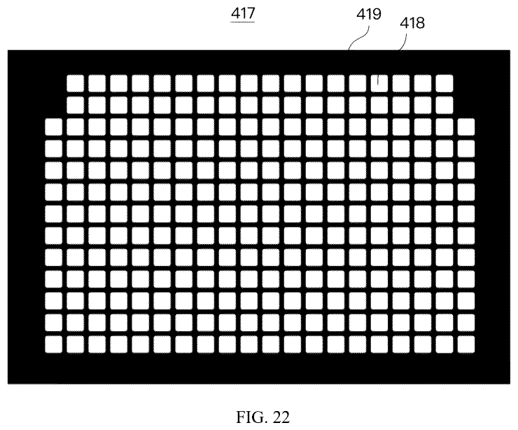

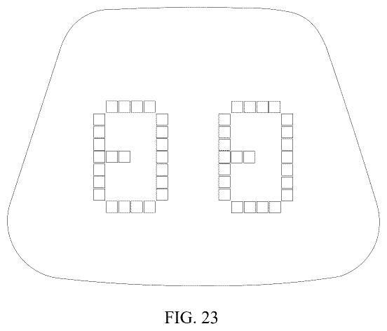

Furthermore, as shown in FIGS. 19 to 40, the display assembly 40 includes a light panel 411 and a light cover 412 configured to cover the light panel 411. The light panel 411 includes a panel body 413 and multiple light-emitting elements 414 arranged on the panel body 413. The light-emitting elements 414 include LEDs, and the light cover 412 includes a numeric light cover and/or a patterned light cover. The light cover 412 defines multiple light-transmitting holes 415 corresponding to the multiple light-emitting elements 414 and includes spacing parts 416 arranged among the multiple light-transmitting holes 415. The spacing parts 416 are made of light-shielding material to isolate the light from adjacent light-emitting elements 414. Each light-emitting element 414 corresponds to one of the light-transmitting holes 415. The light-transmitting holes 415 can be, but not limited to, square, circular, or heart-shaped. In some embodiments, the Bluetooth control board 99b controls the multiple light-emitting elements 414 on the light panel 411 to be activated or disactivated and to display predetermined text and/or patterns in conjunction with the light cover 412. The predetermined text includes numbers. Furthermore, as shown in FIG. 22, in some embodiments, the display assembly 40 further includes a diffusion film 417 arranged on a side of the light cover 412 away from the light panel 411. The diffusion film 417 forms a silk-screened film layer 419 with multiple spaced-apart light-transmitting regions 418. Each light-transmitting region 418 corresponds to one of the light-transmitting holes 415. The silk-screened film layer 419 is a black light-shielding film layer. Each light-transmitting region 418 is configured to diffuse the light from the corresponding light-transmitting hole 415, resulting in softer light emission from the display assembly 40. The light emitted by the light panel 411 passes sequentially through the multiple light-transmitting holes 415 and the light-transmitting regions 418 and is emitted via the decorative shell 42. The shape of the light-transmitting regions 418 determines final patterns displayed on the decorative shell 42. As shown in FIGS. 23 to 40, The final patterns can include, but not limited to, dynamic emoticons or static emoticons.

The front plate 112 includes a wiring hole 118, as shown in FIG. 19, through which the display assembly 40 is electrically connected to the Bluetooth control board 99b via wires.

Furthermore, the rear wheel assembly 22 is detachably connected to the body assembly 10 to facilitate transportation and/or maintenance and replacement. It can be understood that when a child rides the wiggle car 1, they can operate the steering wheel assembly 30, such as twisting it left or right, causing the steering wheel assembly 30 to turn the front wheel assembly 21 left or right, thereby enabling the wiggle car 1 to move forward, left, or right. By connecting the front wheel assembly 21 to the steering wheel assembly 30, users can change the forward direction of the wheel assembly 20 by operating the steering wheel, which is simple and more suitable for children. Additionally, the detachable connection between the rear wheel assembly 22 and the body assembly 10 allows for easy disassembly during transportation and/or maintenance and replacement.

In this embodiment, as shown in FIG. 19, the wiggle car 1 may further include a pedal switch 1170 (which can be placed on the foot pedal 117). The pedal switch 1170 is electrically connected to the control assembly 50 and the motor 98 of the wiggle car 1, and further electrically connected to the circuit board 52. It is configured to output a control signal to control the motor 98 to drive the front wheel assembly 21 when operated by a user. It can be understood that the use of the motor and the pedal switch allows the wiggle car 1 to move using electric power as well as based on user operations, effectively enhancing the user experience.

Specifically, as shown in FIGS. 19, 41, and 42, the wheel assembly 20 further includes a rear wheel mounting bracket 23 arranged within the accommodation cavity 13. At least part of the rear wheel assembly 22 passes through the lower shell 12 and is detachably connected to the rear wheel mounting bracket 23. The lower shell 12 includes a first mounting hole 121 and a second mounting hole 122. At least part of the rear wheel assembly 22 passes through the first mounting hole 121 and is detachably connected to the rear wheel mounting bracket 23. A fastening member 14 passes through the second mounting hole 122 from the outside of the lower shell 12 and is detachably connected to the rear wheel mounting bracket 23 to detachably mount the wheel assembly 20 on the body assembly 10. By providing the fastening member 14, a detachable connection between the rear wheel assembly 22 and the rear wheel mounting bracket 23 can be achieved, which is simple in structure and convenient in operation.

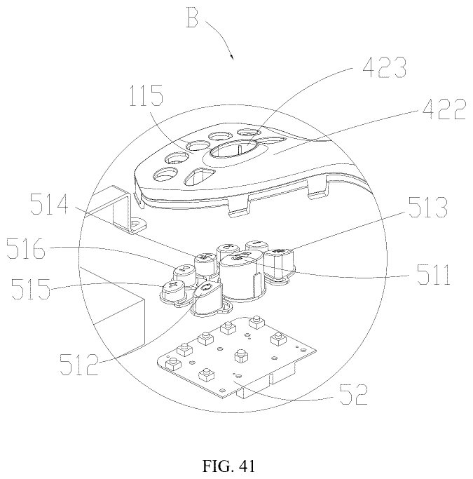

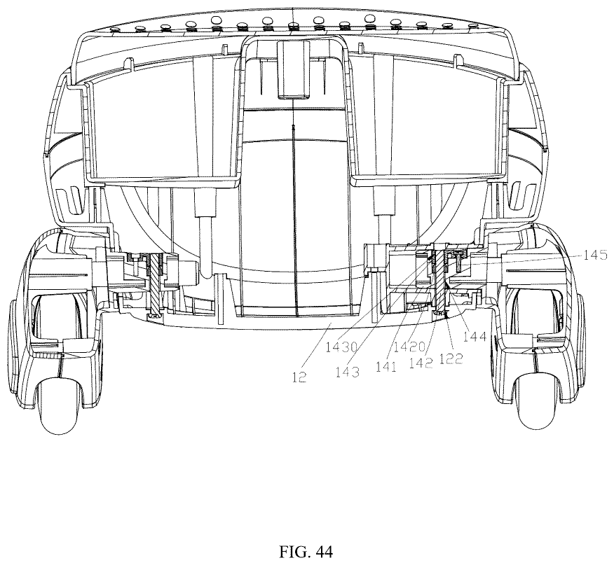

Furthermore, as shown in FIGS. 41 to 43, the lower shell 12 includes a bottom plate 123, a side extension plate 124, and a recessed part 227 connected between the bottom plate 123 and the side extension plate 124. The recessed part 227 is provided with a third mounting hole 228. The rear wheel assembly 22 includes an outer shell 221 and a rear wheel 222 at least partially arranged within the outer shell 221. An mounting shaft part 223 is formed inside the outer shell 221 and passes through the third mounting hole 228 to detachably engage with a fourth mounting hole 231 of the rear wheel mounting bracket 23. The mounting shaft part 223 is of a hollow structure, and the rear wheel assembly 22 further includes a reinforcing member 229, at least part of which is located within the hollow structure and extends into the fourth mounting hole 231. The fastening member 14 includes a fixed post 141 fixedly connected to the outer shell 221, a fastening screw 142, and a nut pressing plate 143. The fixed post 141 includes a fifth mounting hole 144. The fastening screw 142 sequentially passes through the second mounting hole on the lower shell 12 and the fifth mounting hole 144 on the fixed post 141 to be connected with the nut pressing plate 143. Referring to FIG. 44, a nut 1420 is fixed in the fifth mounting hole 144, the nut pressing plate 143 resists against the nut 1420. The nut pressing plate 143 is fixed on the fixed post 141 through a screw 145. The fastening screw 142 extends into the fifth mounting hole 145 from the second mounting hole 122 to be engaged with the nut 1420 and a distal end of the fastening screw 142 extends into a sixth mounting hole 1430 of the nut pressing plate 143. The nut pressing plate 143 resists against the nut 1420, which can prevent the nut 1420 from moving in an axial direction of the fifth mounting hole, thereby stably fixing the fastening screw inside the fifth mounting hole 144. The axial direction of the fifth mounting hole is substantially perpendicular to an extension direction of the fixed post, which can further ensure fastening the connection between the lower shell 12 and the outer shell 221. In this embodiment, the fixed post 141 passes through the first mounting hole 121, and the fastening screw 142 passes through the second mounting hole 122 to secure the rear wheel assembly 22 to the lower shell 12. When disassembling the rear wheel assembly 22, the fastening screw 142 in the second mounting hole 122 can be screwed to exist from the fifth mounting hole 144. At this point, the fastening screw 142 can be withdrawn from the outside of the lower shell 12 to allow exist of the rear wheel assembly 22 from the first mounting hole on the lower shell 12, thereby achieving disassembly of the rear wheel assembly 22 from the lower shell 12. By providing the mounting shaft part 223 and the reinforcing member 229 (which can be a reinforcing steel bar), the connection strength between the rear wheel assembly 22 and the lower shell 12 can be ensured. The mounting shaft part 223 can be installed at an incline relative to the horizontal direction to better fit tightly with the rear wheel mounting bracket 23. Additionally, the arrangement of the two mounting shaft parts 223 also makes the rear leg assembly 22 less prone to swinging, with a larger force-bearing area and more flexible space utilization. Meanwhile, by providing the fastening member 14 and cooperating with the fastening screw 142, the rear wheel assembly 22 can be firmly connected to the lower shell 12 after assembly and locking, and is not prone to detachment.

Furthermore, as illustrated in FIGS. 41 to 43, the rear wheel mounting bracket 23 and the lower shell 12 are secured using screws 60. The outer shell 221 includes a first housing 224 and a second housing 225 arranged on two opposite sides of the rear wheel 222 respectively. The wheel axles on both sides of the rear wheel 222 are fixed within through-holes 226 of the first housing 224 and the second housing 225, respectively. Two nuts 70 are fastened onto the wheel axles on both sides of the rear wheel 222 and are located on the outer side of the outer shell 221. The rear wheel assembly 22 further includes a decorative cover 220. The second housing 225 is situated between the first housing 224 and the body assembly 10, while the decorative cover 220 is mounted on the side of the first housing 224 that is away from the rear wheel 222. The first housing 224 defines a fifth mounting groove 224a, and the decorative cover 220 is installed corresponding to this fifth mounting groove 224a. By providing the first housing 224 and the second housing 225 and securing the rear wheel 222 within them, the rear wheel 222 can be more stably fixed, ensuring safety during use.

Moreover, as shown in FIGS. 41 to 43, the steering wheel assembly 30 includes a steering wheel 31 and a connecting structure 32 attached to one side of the steering wheel 31. The connecting structure 32 passes through the body assembly 10 to connect with the front wheel assembly 21. The front wheel assembly 21 includes a mounting structure 211, a front wheel 212 positioned at the front of the mounting structure 211, and two auxiliary wheels 213 located at the rear of the mounting structure 211. By providing the connecting structure 32 and the mounting structure 211, the steering wheel assembly 30 can be stably connected to the body assembly 10. Additionally, the arrangement of the two auxiliary wheels 213 at the rear of the mounting structure 211 and the front wheel 212 at the front forms a triangular stability structure, making the wiggle car 1 more stable and safer during use. This design allows for better performance on various road surfaces, enhancing the user experience.

The above-described embodiments merely illustrate several embodiments of the present disclosure, and the description thereof is relatively specific and detailed, but it should not be construed as limiting the scope of patent protection. It should be pointed out that, for ordinary skilled in the art, several modifications and improvements can be made without departing from the concept of the present disclosure, which all fall within the scope of protection of the present disclosure. Therefore, the protection scope of the present disclosure should be determined by appended claims.

1. A wiggle car, comprising
a body assembly, configured for a user to ride in;
a wheel assembly, arranged at a bottom of the body assembly and comprising a front wheel assembly arranged at a front end of the body assembly and a rear wheel assembly arranged at a rear end of the body assembly;
a steering wheel assembly, connected to the body assembly and the front wheel assembly and configured to drive the front wheel assembly to rotate to allow the user change a forward direction of the wheel assembly by operating the steering wheel assembly;
a control assembly, comprising a power switch key and a circuit board; the power switch key is connected to the circuit board;
a support member, connected to the body assembly and configured to rotatably sleeve on the steering wheel assembly;
a first electrical connection assembly, connected to the front wheel assembly via a first wire, and the steering wheel assembly is configured to bring the first electrical connection assembly to rotate along with the front wheel assembly when the front wheel assembly is driven to rotate by the steering wheel assembly; and
a second electrical connection assembly, connected to the circuit board via a second wire; both the circuit board and the second electrical connection assembly are arranged on the support member;
the first electrical connection assembly is configured to keep resisting against the second electrical connection assembly to ensure an electrical connection between the first electrical connection assembly and the second electrical connection assembly during rotation of the first electrical connection assembly along with the front wheel assembly.

2. (canceled)

3. (canceled)

4. The wiggle car according to claim 1, wherein
the first electrical connection assembly comprises a rotating body configured to sleeve on the steering wheel assembly and two electrical ring pieces disconnected from each other; the rotating body is configured to be mounted on the front wheel assembly and is rotatably arranged inside the support member;
the two electrical ring pieces are arranged on an outer side of the rotating body, or, one of the two electrical ring pieces is arranged on the outer side of the rotating body and another of the two electrical ring pieces is arranged on an upper surface of the front wheel assembly facing the support member;
two leads at an end of the first wire are connected to the two electrical ring pieces respectively; and
the second electrical connection assembly comprises two electrical contact assemblies, the support member is provided with two first mounting slots corresponding to the two electrical ring pieces respectively, the two electrical contact assemblies are configured to be arranged in the two first mounting slots respectively, two first through-holes are defined in the two first mounting slots respectively and are configured to allow the two electrical contact assemblies to pass therethrough to resists against the two electrical ring pieces respectively, two leads at an end of the second wire are connected to the two electrical contact assemblies respectively.

5. The wiggle car according to claim 1, wherein the front wheel assembly is provided with a placement slot on a side facing the support member, the second electrical connection assembly comprises a rotating body configured to sleeve on the steering wheel assembly and two electrical ring pieces disconnected from each other; the rotating body is configured to be mounted on an inner side of the support member and is rotatably arranged in the placement slot;
the two electrical ring pieces are arranged on an outer side of the rotating body, or, one of the two electrical ring pieces is arranged on the outer side of the rotating body and another of the two electrical ring pieces is arranged on a bottom surface of the support member facing the front wheel assembly;
two leads at an end of the second wire are connected to the two electrical ring pieces respectively; and
the first electrical connection assembly comprises two electrical contact assemblies, the front wheel assembly is provided with two second mounting slots corresponding to the two electrical ring pieces respectively, the two electrical contact assemblies are configured to be arranged in the two second mounting slots respectively, two second through-holes are defined in the two second mounting slots respectively and are configured to allow the two electrical contact assemblies to pass therethrough to resists against the two electrical ring pieces respectively, two leads at an end of the first wire are connected to the two electrical contact assemblies respectively.

6. The wiggle car according to claim 1, wherein each of the first electrical connection assembly and the second electrical connection assembly comprises an electrical ring piece and an electrical contact assembly, each of the support member and the front wheel assembly is provided with a third mounting slot, one of the two electrical ring pieces is arranged on an upper surface of the front wheel assembly facing the support member, and another of the two electrical ring pieces is arranged on a bottom surface of the support member facing the front wheel assembly, the third mounting slot on the front wheel assembly corresponds to the third mounting slot on the support member, the two electrical contact assemblies are configured to be mounted on the two third mounting slots respectively, two leads at an end of the first wire are connected to the electrical ring piece on the front wheel assembly and the electrical contact assembly on the front wheel assembly; and two leads at an end of the second wire are connected to the electrical ring piece on the support member and the electrical contact assembly on the support member.

7. The wiggle car according to claim 1, wherein
the second electrical connection assembly comprises two electrical ring pieces arranged on a bottom surface of the support member facing the front wheel assembly and disconnected from each other, two leads at an end of the second wire are connected to the two electrical ring pieces, the first electrical connection assembly comprises two electrical contact assemblies, the front wheel assembly is provided with two fourth mounting slots corresponding to the two electrical ring pieces, the two electrical contact assemblies are configured to be mounted in the two fourth mounting slots and are configured to resists against the two electrical ring pieces respectively, and two leads at an end of the first wire are connected to the two electrical contact assemblies.

8. The wiggle car according to claim 4, wherein each electrical ring piece is connected with a pin having a third through-hole configured to allow the first wire or the second wire to pass therethrough to be electrically connected to the electrical ring piece.

9. The wiggle car according to claim 4 wherein each electrical contact assembly comprises an electrical contact block configured to resists against a corresponding one of the two electrical ring piece and a reset member; one end of the reset member is configured to resists against the first mounting slot, and another end of the reset member is configured to resist against the electrical contact block.

10. The wiggle car according to claim 8, wherein a mounting protrusion is arranged at a side of the electrical contact block facing the reset member and the reset member is configured to sleeve on the mounting protrusion.

11. The wiggle car according to claim 1, wherein the body assembly comprises an upper shell and a lower shell connected to each other to define an accommodation cavity, the upper shell comprises a seat plate, a front plate connected to the seat plate, two side plates connected to the seat plate and two opposite sides of the front plate, and two foot pedals connected to an outer side of the two side plates respectively; and
the display assembly comprises a display element arranged on an outer side of the front plate; the display assembly further comprises a decorative shell; the decorative shell comprises a first decorative part configured to cover a side of the display element opposite to the front plate, and the first decorative part comprises a translucent material configured to allow the display element to display predetermined patterns and/or text via the first decorative part.

12. The wiggle car according to claim 11, wherein the seat plate comprises a seat plate body and an operation panel connected between the seat plate body and the front plate; the control assembly comprises at least one adjustment control key arranged on the operation panel, the at least one adjustment control key is electrically connected to the circuit board and is configured to generate control signals based on user's operation, the circuit board is configured to control display of the display assembly and functions of other functional assemblies, and the other functional assemblies comprise a speaker assembly and a light assembly; and functions of the other functional assemblies comprise sound, music and light effects.

13. A wiggle car, comprising:
a body assembly, configured for a user to ride in;
a wheel assembly, arranged at a bottom of the body assembly and comprising a front wheel assembly arranged at a front end of the body assembly and a rear wheel assembly arranged at a rear end of the body assembly;
a steering wheel assembly, connected to the body assembly and the front wheel assembly and configured to drive the front wheel assembly to rotate to allow the user change a forward direction of the wheel assembly by operating the steering wheel assembly;
a display assembly, arranged on a front outer surface of the body assembly and configured to display predetermined patterns or texts;
wherein the display assembly comprise a light panel and a light cover configured to cover the light panel; the light panel comprises a panel body and a plurality of light-emitting elements arranged on the panel body; the plurality of light-emitting elements comprise LEDs, the light cover comprises a plurality of light-transmitting parts corresponding to the plurality of light-emitting elements respectively and a plurality of spacing parts arranged among the plurality of light-emitting elements, each light-emitting element corresponds to a corresponding one of the plurality of light-transmitting parts, the spacing part are made of light-shielding material configured to isolate light from adjacent light-emitting elements;
wherein the display assembly further comprises a diffusion film; the diffusion film comprises a silk-screened film layer with multiple spaced-apart light-transmitting regions; each light-transmitting region corresponds to a corresponding one of the light-transmitting parts; the silk-screened film layer is a black light-shielding film layer; each light-transmitting region is configured to diffuse light out from the corresponding one of the light-transmitting parts to have light emitted from the display assembly softer; each light-emitting part is a light-emitting hole; the light emitted by the light panel is configured to pass sequentially through the light-transmitting holes and the light-transmitting regions and to be emitted via a decorative shell to allow the decorative shell to display the predetermined patterns, the predetermined patterns comprises at least one of numbers, letters, characters and preset graphics; and a shape of each light-transmitting region determines the redetermined patterns.

14. A wiggle car, comprising:
a body assembly, configured for a user to ride in; wherein the body assembly comprises an upper shell and a lower shell; the upper shell is connected to the lower shell to form an accommodation cavity; the upper shell comprises a seat plate, a front plate connected to a front side of the seat plate, two side plates connected to the seat plate and two opposite sides of the front plate, and two pedals connected to an outer side of the two side plates respectively;
a wheel assembly, arranged at a bottom of the body assembly and comprising a front wheel assembly arranged at a front end of the body assembly and a rear wheel assembly arranged at a rear end of the body assembly; wherein the rear wheel assembly is detachably connected to the body assembly to facilitate transportation and maintenance; and
a steering wheel assembly, connected to the body assembly and the front wheel assembly and configured to drive the front wheel assembly to rotate to allow the user change a forward direction of the wheel assembly by operating the steering wheel assembly;
wherein the wheel assembly further comprises a rear wheel mounting bracket arranged in the accommodation cavity; and at least part of the rear wheel assembly is configured to pass through the lower shell to be detachably connected to the rear wheel mounting bracket.

16. The wiggle car according to claim 14, wherein the lower shell further comprises a first mounting hole and a second mounting hole, the lower shell is configured to at least partially pass through the first mounting hole to be detachably connected to the rear wheel mounting bracket; a fastening member is configured to pass through the second mounting hole from an outer side of the lower shell to be detachably connected to the rear wheel assembly to detachably mount the wheel assembly onto the body assembly.

17. The wiggle car according to claim 16, wherein the lower shell comprises a bottom plate, a side extension plate, and a recessed part connected between the bottom plate and the side extension plate; the recessed part defines a third mounting hole; the rear wheel assembly comprises an outer shell and a rear wheel at least partially accommodated in the outer shell; an outer side of the outer shell is provided with at least two mounting shaft parts; the mounting shaft parts are inclined relative to a horizontal direction after being mounted onto the rear wheel mounting bracket; the mounting shaft parts are configured to pass through the third mounting hole to be detachably engaged with a fourth mounting hole on the rear wheel mounting bracket.

18. The wiggle car according to claim 17, wherein the mounting shaft parts are of a hollow structure, the rear wheel assembly further comprises two reinforcing members; the two reinforcing members are at least partially arranged in the hollow structure and extends into the fourth mounting hole; the fastening member comprises a fixed post fixedly connected to the outer shell, a fastening screw, and a nut pressing plate; the fixed post defines a fifth mounting hole, the fastening screw is configured to sequentially pass through the second mounting hole on the lower shell and the fifth mounting hole on the fixed post to be connected with the nut pressing plate, so as to mount the rear wheel assembly onto the lower shell.

19. The wiggle car according to claim 17, wherein the rear wheel mounting bracket and the lower shell are connected through a screw; the outer shell comprises a first housing and a second housing arranged on two opposite sides of the rear wheel respectively; wheel axles on both sides of the rear wheel are fixed in through-holes on the first housing and the second housing respectively; two nuts are fastened onto the wheel axles on both sides of the rear wheel and are located on the outer side of the outer shell; the rear wheel assembly further comprises a decorative cover; the second housing is arranged between the first housing and the body assembly, and the decorative cover is arranged on a side of the first housing opposite to the rear wheel.

20. The wiggle car according to claim 1, wherein the steering wheel assembly comprises a steering wheel and a connecting structure connected to a side of the steering wheel; the connecting structure is configured to pass through the body assembly to be connected to the front wheel assembly; the front wheel assembly comprises a mounting structure, a front wheel arranged on a front side of the mounting structure, and two auxiliary wheels arranged on a rear side of the mounting structure.

21. (canceled)

22. The wiggle car according to claim 14, further comprising a motor arranged in the front wheel assembly and electrically connected to the circuit board;
the wiggle car further comprises a pedal switch electrically connected to the control assembly and is configured to output a control signal to control the motor to drive the front wheel assembly to work when operated by the user.
